(19) United States
(12) Patent Application Publication
(10) Pub. No.: US 2005/0050025 A1
(43) Pub. Date: Mar. 3, 2005

(54) Information gathering system, information gathering method, personal digital assistant

(76) Inventors: Kenichirou Kurata, Hitachinaka (JP); Munetoshi Unuma, Hitachinaka (JP); Ryoichi Tanaka, Kokubunji (JP); Kenichi Hamazaki, Yokohama (JP)

Correspondence Address: MCDERMOTT, WILL & EMERY, 600 13th Street, N.W., Washington, DC, 20005-3096, US

(21) Appl. No.: 10/786,155

(22) Filed: Feb. 26, 2004

(30) Foreign Application Priority Data
Jun. 23, 2003 (JP) 2003-177437

(51) Int. Cl. G06F 7/00

(52) U.S. Cl. 707/3

(57) ABSTRACT

An information gathering system is provided which can gather information from input data or output data of a terminal, without requiring a specific operation of a user. The system includes servers and terminals connected over a network. In this system, at least one or more keywords are specified in advance and stored in a keyword list holding unit. Then, a keyword recognition unit detects a match or association between one of the keywords and information input to an input unit or output from an output unit in the terminal. With this arrangement, specific information is acquired.

### BACKGROUND OF THE INVENTION

1. Field of the Invention

The present invention relates to a data mining system for obtaining data used for market research or the like.

2. Description of the Related Art

When information is to be obtained from a user so as to perform the market research, it is a common practice to ask questions to the user by a direct mail or the like and obtain responses from the user. JP-A-2002-207857 discloses a method in which using a server and a terminal connected over a network, transmission and reception of data such as a text is performed for the user, and questions are asked to the user one by one in response to replies to the questions from the user, thereby gathering information. JP-A-2002-297645 and JP-A-11-296525 disclose a technique by which voice data input to a terminal is recognized for extraction of a broad range of keywords, which will be referred to as KWs below, an appropriate KW is selected from among the extracted KWs, and then information associated with the selected KW is acquired at the terminal.

When the market research is performed by the conventional method, it is difficult to obtain information imparted through word-of-mouth communication, which is information indicating a user's real feeling about a product. It is because if information is acquired by asking the user questions prepared in advance and then getting replies to the questions from the user, the user would become conscious of the existence of the questions or a questioner, so that the user thinks in a way he does not usually take; thus, it becomes difficult to acquire the information under a free-thinking state of the user and the information that reflects user's daily life. The information imparted through word-of-mouth communication can be said to be niche information in view of information distributed through media such as newspapers, magazines, and television. However, since the information imparted through word-of-mouth communication is the information based on personal experiences, it is highly credible and is quickly distributed because it spreads by word of mouth. Thus, it often happens that the information has become an open secret when it gets a lot of attention in the media. Catching such information early and utilizing the information for business can contribute to making a great profit.

Since the other party in a cellular phone call or the like is often a close friend, a sweetheart, or other acquaintance, it may often happen that interesting information or useful information will be conveyed to the other party. Accordingly, if the method is used in which contents of a voice call of the cellular phone or the like are recognized, KWs are extracted from the call, and then the market research using these KWs is performed, information imparted through out-of-mouth communication can also be gathered.

However, use of this method might induce privacy invasion; because it is necessary to perform processing in which voice recognition of entire data in the voice call is performed for conversion into sentences in text format, syntax analysis of the sentences in text format is performed, and then KWs are separated and extracted from the sentences.

### SUMMARY OF THE INVENTION

An object of the present invention is to gather information imparted through out-of-mouth communication without invading personal privacy. A further object of the present invention is to provide information for early tracking a market trend.

In order to achieve the above-mentioned objects, an information gathering method of the present invention includes:
preparing at least one or more KWs selected in advance;
determining whether data input to a terminal such as the one for the cellular phone matches at least one of the KWs or associates with the KWs; and
obtaining information on the KW when there is a match between the input data and the KW.

According to the present invention, information imparted through word-of-mouth communication can be gathered without invading individual privacy. Further, information for early tracking a market trend can be provided.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a basic structure of an information gathering system according to the present invention;

FIG. 2 is an explanatory drawing explaining a connecting condition among terminals, an information gathering server, and information research servers described with reference to FIG. 1;

FIG. 3 is a flowchart showing basic flows of processing in the information gathering system according to the present invention;

FIG. 4 is an explanatory table showing a structure of data to be transmitted from the information gathering server to each of the terminals;

FIG. 5 is an explanatory table showing a structure of data to be transmitted from the information gathering server to the information research servers;

FIG. 6 is a display screen displayed on the terminal before KW recognition is started;

FIG. 7 is a display screen displaying a list of KWs for recognition;

FIG. 8 is a display screen confirming to a user whether information obtained from the KW recognition may be transmitted to the information gathering server or not;

FIG. 9 is a display screen displaying information obtained from the KW recognition to the user;

FIG. 10 is a display screen showing that a KW has been detected and information is being gathered;

FIG. 11 is a flowchart showing contents of processing for deleting information after a KW has been detected and information obtained from recognition of the KW has been once transmitted to the information gathering server;

FIG. 12 is a display screen for selecting information to be deleted;

FIG. 13 is a display screen showing that data deletion cannot be performed because a data gathering period has been completed; and

FIG. 14 is a confirmation screen showing that information obtained from the terminal and transmitted to the information gathering server has been deleted.

### DESCRIPTION OF THE EMBODIMENT

An embodiment of the present invention will be described below.

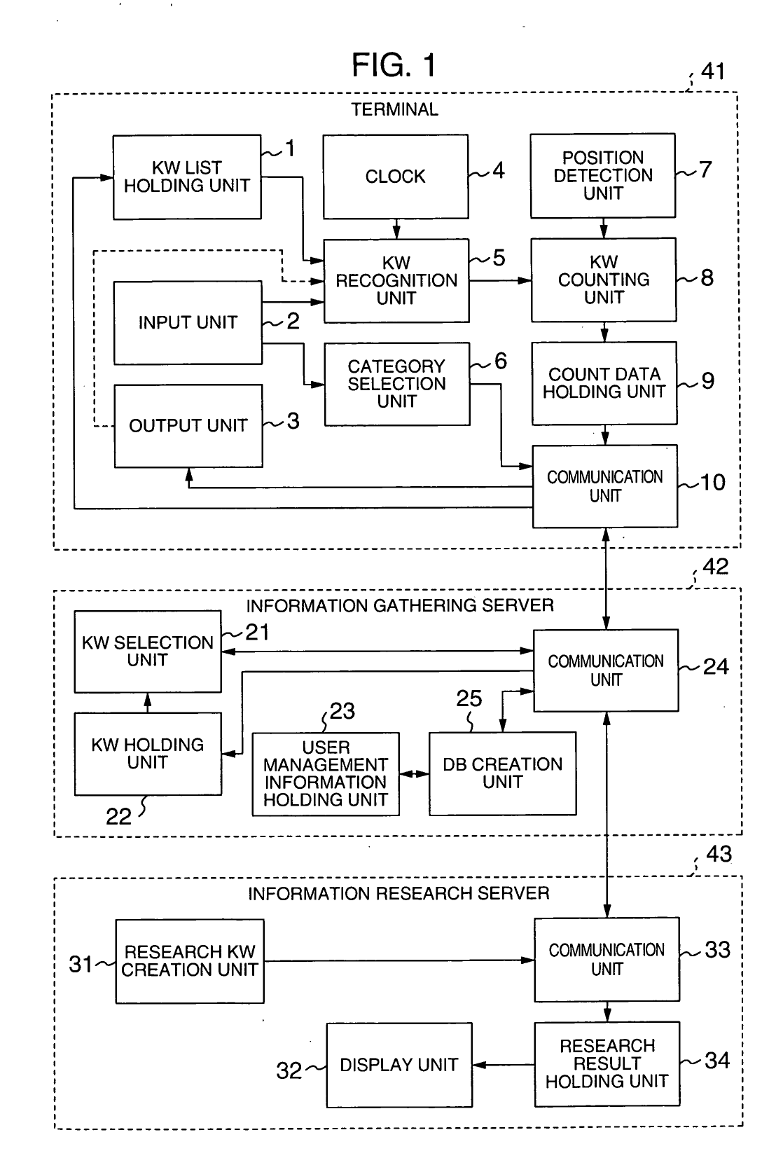

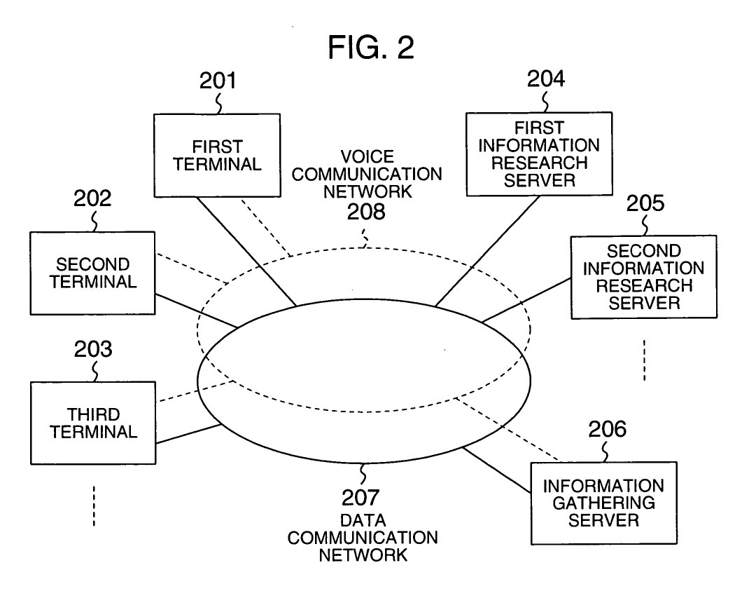

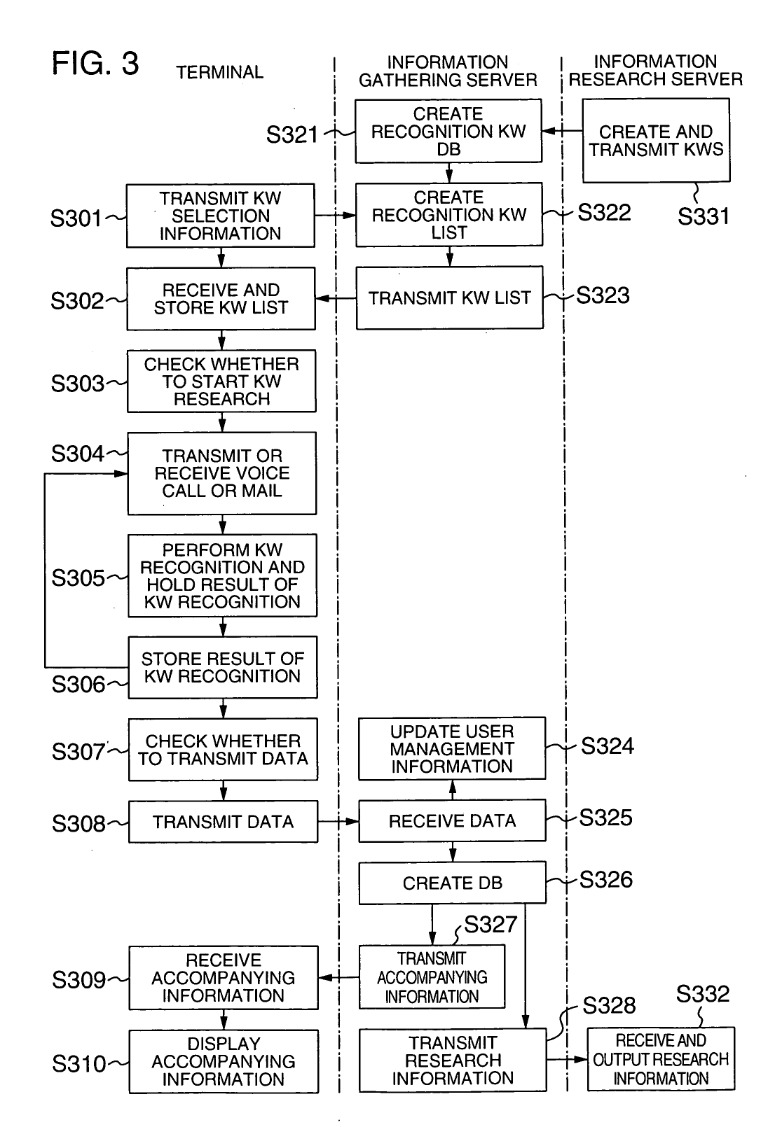

A terminal 41 is a cellular phone or the like held by a user. A person who wishes to perform market research to know what design of a household electric appliance should be sold holds an information research server 43. A person who actually performs the market research at the request of the person who holds the information research server 43 holds an information gathering server 42. The relationship between the terminal, the information research sever, and the information gathering server is as shown in FIG. 3. FIGS. 1 and 2 show a system configuration among them. FIG. 1 shows an information gathering system constituted from the terminal 41, information gathering server 42, and information research sever 43. The information gathering system is connected through a data communication network 207, as shown in FIG. 2. To the data communication network 207, in addition to an information gathering server 206, a first terminal 201, a second terminal 202, and a third terminal 203 are connected as terminals 41, and a first information research server 204 and a second information research server 205 are connected as information research servers 43. In this embodiment, a plurality of terminals are connected to the information gathering server, which uses results of KW recognition of data inputs into the plurality of terminals to create a database (DB) of KW occurrence. A plurality of information research servers is also provided to enable KW recognition about a plurality of fields. In FIG. 2, only one information gathering server 206 is shown; however, by providing a plurality of information gathering servers and distributing processing, data can be gathered from more terminals and data on a plurality of fields can be gathered.

Referring to FIG. 1, each component of the information gathering system of the present invention will be described.

The terminal 41 is used by the user, and performs data input and output of voice, a character, an image, and the like. The terminal 41 includes an input unit 2, an output unit 3, a category selection unit 6, a communication unit 10, a KW list holding unit 1, a KW recognition unit 5, a KW counting unit 8, a count data holding unit 9, a clock 4, and a position detection unit 7. The input unit 2 receives an input from the user, and corresponds to a keyboard for inputting a text, a microphone for inputting voice, a telephone mouthpiece, or the like. When the cellular phone is employed as the terminal 41, a unit for receiving a voice call and converting the voice call into a data format that can be processed by a microcomputer or the like corresponds to the input unit 2. The output unit 3 displays and outputs necessary information to the user, and corresponds to a terminal screen or a loudspeaker that outputs voice or the like.

The category selection unit 6 selects which field of information gathering the user participates in, in the information gathering system, according to an input from the input unit 2 and sends category selection information to the information gathering server 42 through the communication unit 10. The category selection unit 6 can also be configured to transmit information useful for category selection such as the information on an age, a gender, and an interested field input in advance to the information gathering server 42 when necessary, in addition to performing processing for sending the category selection information.

According to the AIDCA rule, before buying a product, a customer undergoes following psychological changes: first, he directs attention to the product. Then, he has interest in the product, and creates desire for the product. Then, he has conviction that he can get satisfaction by purchasing the product. Finally, he takes action toward purchasing the product. By narrowing down categories for obtaining information to the categories of user's strong interest as described above, the same effect as the result of research on humans alone, of whom attention and interest are provoked, may be obtained, so that a result close to the result of the market research targeting prospects may be obtained. More specifically, accuracy of information gathering can be more increased than in a case where the information gathering system is used for the market research and the like, and information on the user close to buyers can be obtained.

The communication unit 10 performs communication with a communication unit 24 provided for the information gathering server over the data communication network to transmit or receive data between the terminal and the information gathering server. The KW list holding unit 1 holds a list of KWs for recognition transmitted from the information server 42. The KW recognition unit 5 performs KW recognition of data input to the input unit 2. When the KW recognition unit 5 has detected a KW that matches one of the KWs held in the KW list holding unit 1, the KW recognition unit 5 sends to the KW counting unit 8 information for identifying the detected KW. When the input data is in the format of voice or text, a complete match between the KW in the input data and the KW held in the KW list holding unit 1 is not necessary. Even if there is a difference of one character between the spellings of the KWs or the voice input is not precisely accented, KW detection is performed only if the KWs have been found to be the same through appropriate processing. Addition of such processing places a greater burden on processing for the KW recognition. However, it becomes possible to detect all of information input, being intended by the user as the KW, even if the input KW is misspelled or peculiar. Information to be output from the output unit 3 can also be input to the KW recognition unit 5 as shown in a dotted line from the output unit 3 to the KW recognition unit 5, and KW recognition of the information can also be performed. With this arrangement, KW recognition of the information transmitted to the terminal as well the information sent forth from the user of the terminal can also be performed; information can be thereby gathered from a more extensive information source.

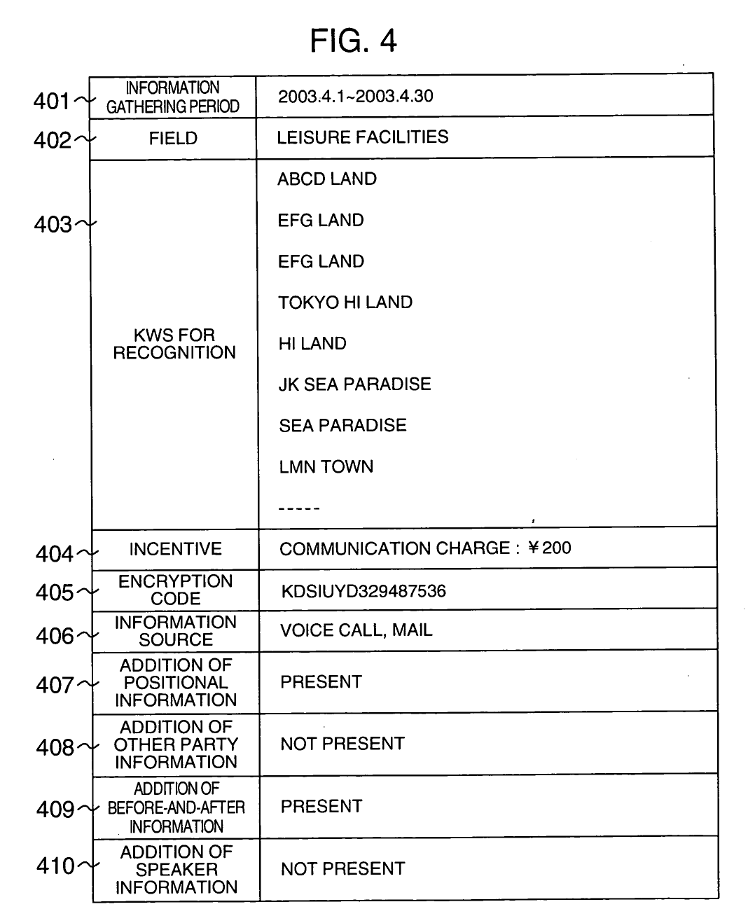

The KW counting unit 8 counts the number of times the KW recognition unit 5 has detected a KW. The KW counting unit 8 counts the number of times each KW held in the KW list holding unit 1 has been detected and increments the value of the detected KW in the count data holding unit 9 for each detection. Every time a specified KW has been detected, the count data holding unit 9 holds data while updating the frequency of occurrence of the KW corresponding to the specified KW. When the period of KW recognition at the terminal 41 is specified, the KW recognition unit 5 performs the KW recognition by referring to the clock 4, thereby performing data gathering. When the specified period has elapsed, the terminal 41 finishes the KW recognition and sends data in the count data holding unit 9 to the information gathering server 42 through the communication unit 10. In an example in FIG. 4, the period for the research is set to one month.

The position detection unit 7 obtains the position of a terminal, and can use a technology such as the GPS (Global Positioning System), for example. Positional information detected by the position detection unit 7 is input to the count data holding unit 9 through the KW counting unit 8. The positional information of the terminal at a point in time when a KW has been detected is held together in the count data holding unit 9. As described above, it is also possible to convert this point information in regard to the terminal into plane information indicating whether the terminal is located in a specified area or not and create an association between the plane information and the detected KW, instead of associating point information. Association using the plane information helps more to reduce the amount of information.

With the above-mentioned arrangement, it becomes possible to associate the position of a terminal at a point in time when a KW has been detected with the KW and hold the positional information. This makes it possible for the information gathering server 42 to create KW occurrence data according to the position or the area where a terminal is located.

The information gathering server 42 transmits KWs to the terminal 41 over the data communication network 207 shown in FIG. 2, and also receives data obtained by performing KW recognition at the terminal to create the database (which will be hereinafter referred to as the DB) of KW occurrence frequencies. The information gathering server 42 includes a KW selection unit 21, a KW holding unit 22, a user management information holding unit 23, a communication unit 24, and a DB creation unit 25. The KW holding unit 22 holds a list of KWs created in advance for each category for which the research is performed. The KW list is obtained from the information research sever 43 through reception or the like. It means that a request for the research using the list has been made. Alternatively, an information gatherer having the information gathering server may create the list after receiving the request for research on an abstract content. The KW holding unit 22 holds the period and location of the KW recognition and other conditions for each category, in addition to the KW list. By transmitting these data to the terminal 41 together with the KW list, appropriate KW recognition becomes possible.

As described above, the KW selection unit 21 selects KWs from among KWs held in the KW holding unit 22 according to the category and creates the KW list. Category information is received from the terminal 41 through the communication unit 24. Alternatively, it may also be configured to obtain information on users of the terminals connected to the information gathering server 42 from the user management information holding unit 23, which will be described later, and automatically select an optimal category. The KW list created by the KW selection unit 21 is transmitted to the terminals through the communication unit 24. The data in the count data holding unit 9 obtained by the terminal 41 is input to the DB creation unit 25 through the communication unit 24. Data from a plurality of terminals 41 connected to the information gathering server 42 are thus totalized in the information gathering server 42. Information necessary for the market research such as the occurrence time, occurrence frequency, and occurrence rate of each KW in a specified KW list can be obtained for each KW.

The user management information holding unit 23 stores information on users who use the terminals 41. The information on the users includes ages, genders, hobbies, and interested fields of the users. By using the information on the users, stored in the user management information holding unit 23 and detailing the DB of the KW occurrence frequencies, the DB can accommodate such characteristics as the ages, genders, and interested fields. Thus, it can be expected that the usefulness of the DB be enhanced, as described above.

Further, in order to provide service that grants an incentive for transmission of a result of the KW recognition to the users of the terminals 41, a history of data reception is stored in the user management information holding unit 23 when the data in the count data holding unit 9 has been received through the communication unit 24. By referring to this history, users' interests can be tracked as follows: a user 1 is interested in a baseball team A, a user 2 is interested in jeans, and a user 3 is interested in . . . , and so on.

Further, it is desirable to provide a configuration in which deletion of data that the user has once transmitted is performed if he wishes the deletion so that the deleted data is not included in the data created by the DB creation unit 25.

The information research sever 43 is provided to perform market research on a specific field, and is provided by a market research company, for example. The information research sever 43 includes a research KW creation unit 31, a display unit 32, a communication unit 33, and a research result holding unit 34. The research KW creation unit 31 creates KWs to be stored in the KW holding unit 22 and then sent to the terminal 41 for the KW recognition, and creates an appropriate list of KWs such as the names of products, the names of facilities, and the names of persons to be subject to comparison research, according to the research field. The KW list may be automatically created using a KW automatic gathering program or the like. However, if the KW list is created and then registered by a human such as an operator, a knowhow in the market research can be fully utilized, so that a more-carefully-selected and appropriate KW list can be sometimes created. By manually creating the KW list, keywords can be narrowed down more effectively. Further, information that will become noise for desired data can also be reduced. The result of the market research may include the information that will become noise. However, if the KW list is created manually and the need for processing such as reduction of the information that will become noise is eliminated, it becomes possible to reach a desired result of the market research comparatively early. If a market trend can be identified quickly, it becomes possible for a company that would sell character goods, for example, to determine which character to select in an early stage, which may help in concluding a character use contract or the like.

The research result holding unit 34 receives data on the occurrence times or the occurrence frequencies of the KWs created by the DB creation unit 25 after the information gathering server 42 gathered and totalized data from the terminals 41, and stores the data therein. The data stored in the research result holding unit 34 shows the result of the market research and is used by a method of displaying it on the display unit 32 or the like.

FIG. 3 is a flowchart showing a flow of processing and a flow of data in the information gathering system shown in FIG. 1. From the left of the drawing, processing of the terminal 41, processing of the information gathering server 42, and processing of the information research sever 43 are shown. First, an outline of overall processing will be described. Lists of KWs in fields to be researched are sent to the information gathering server from the information research server. Then, the field targeted for the market research is selected from among the fields stored in the information gathering server, by the terminal used by the user, and the KW recognition for the selected field is performed. Data resulting from the KW recognition are totalized by the information gathering server to create the DB, thereby performing the market research. As a final step, the DB of the gathered data is transmitted from the information gathering server to the information research server to complete the overall processing.

Next, steps of the processing, which are details of the processing, will be described. First, the lists of the KWs to be researched by the market research company or the like are created, and the KW lists are transmitted to the information gathering server from the information research server at step S331. This embodiment assumes that the KW lists are transmitted through communication over the data communication network. However, the KW lists can also be sent using a telephone, by fax, or by mail and the KW lists can be passed to the information gathering server in the form of input by the operator, as described before.

On the other hand, a recognition KW DB is created by the information gathering server using the KW lists at step S321. This embodiment assumes the market research on a plurality of fields. Thus, the recognition KW DB created at step S321 includes a plurality of the lists of the KWs for recognition, which are stored in the KW list holding unit shown in FIG. 1.

Next, processing for selecting a KW list for performing the KW recognition is performed. This embodiment shows an example where the user selects the field in which he is interested and the KW recognition for the field is performed.

At step S301, information on KW selection is transmitted from the terminal. As the information on the KW selection, the field of the KW list provided in the information gathering server may be directly specified by the user. Alternatively, source data for selecting the field such as user information and positional information on the terminal may be transmitted. At step S322, the list of the KWs for recognition is created by the information gathering server, using the information on the KW selection transmitted at step S301. This processing is performed by the KW selection unit 21 shown in FIG. 1.

The KW list created at step S322 is transmitted to the terminal at step S323. The operation then proceeds to step S302, where the terminal receives the KW list and stores it in the KW list holding unit 1.

Next, the operation at the terminal proceeds to step S303, and confirmation as to the start of research using the KWs is performed. In a scheme where the user acquires specific information from the information freely input by the user, personal information of the user might be gathered, thereby invading the privacy of the user. This system, however, recognizes input information within the range of the KW list alone and researches the occurrence times of the KWs. Thus, there is no danger that other information may be randomly acquired. However, the user may sometimes wish no acquirement of data from transmitted personal information. The operation at step S303 is performed in view of this user's wish, and is performed to confirm to the user whether the research using the KW recognition may be conducted or not before the start of the research.

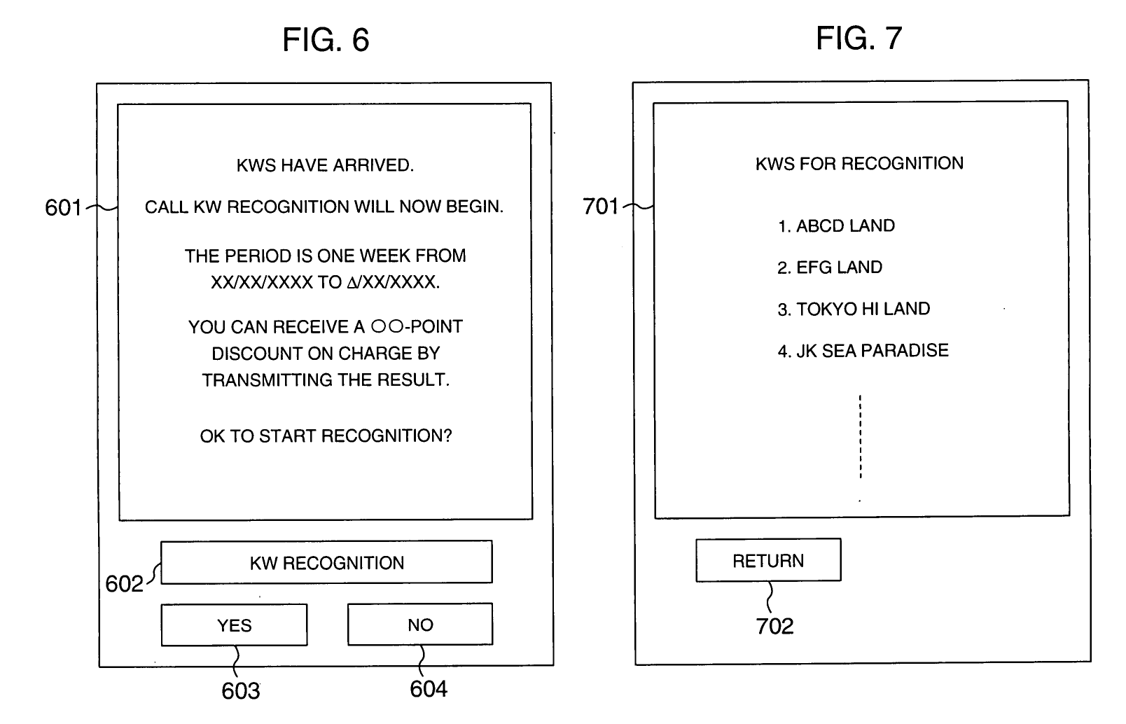

FIG. 6 shows an example of a confirmation screen at this point. Referring to FIG. 6, information gathering criteria, an information gathering period, an incentive granted when the user has cooperated in information gathering are shown on a screen 601, and the user selects a “yes” button 603 or a “no” button 604 in response to a question on the screen 601 asking whether the KW recognition may be started. Depending on the KW for recognition, the user sometimes considers that the research may be performed. Thus, a button 602 that enables KW confirmation is further provided. When the user has selected the KW confirmation, the screen for the KW confirmation shown in FIG. 7 appears, and a KW list 701 is displayed. The KW displayed on this screen may display all the KWs in the list of the KWs for recognition. Alternatively, typical KWs may be selected in advance, for display. Since the screen for the KW confirmation in FIG. 7 is invoked for a confirmation purpose, only display of the typical KWs can sufficiently serve its purpose. After the KW confirmation has been performed on the screen in FIG. 7, a “return” button 702 is selected to return the screen to the one in FIG. 6 for starting the research using the KW recognition.

Referring to FIG. 6, when the “no” button 604 has been selected, processing after step S304 shown in FIG. 3 is not performed. When the “yes” button 603 in FIG. 6 has been selected, the operation proceeds to processing from step S304 to step S306, so that transmission or reception of a voice call or mail, the KW recognition and holding the result of the KW recognition, and storage of the result of the KW recognition are performed. During a period specified for performing the research, the loop from step S304 to step S306 is performed without cessation, so that the result of the KW recognition is updated. More specifically, while the voice call is performed, for example, the KW recognition is performed at all times during the call. When one of the KWs included in the KW list has been detected, processing at step S305 for performing the KW recognition and holding the result of the KW recognition and processing at S306 for storing the result of the KW recognition are kept on being performed until completion of the call. If text information such as mail is input, processing is started when the input information has been fixed, e.g. at the time of transmission of the input information. The KW recognition at step S304 is performed for each word in transmitted sentences. Then, when one of the KWs included in the KW list has been detected, processing at step S305 and step S306 is performed and continued until no word is found in the transmitted sentences. Among the processing at these steps, transmission or reception of the voice call and mail at step S304 are performed by the input unit 2 in FIG. 1; the KW recognition is performed by the KW recognition unit 5 in FIG. 1; processing for counting up the occurrence time of a KW in the associated DB when the KW has been detected is performed by the KW counting unit 8 in FIG. 1; and processing for storing the data associated with the KW is performed by the count data holding unit 9.

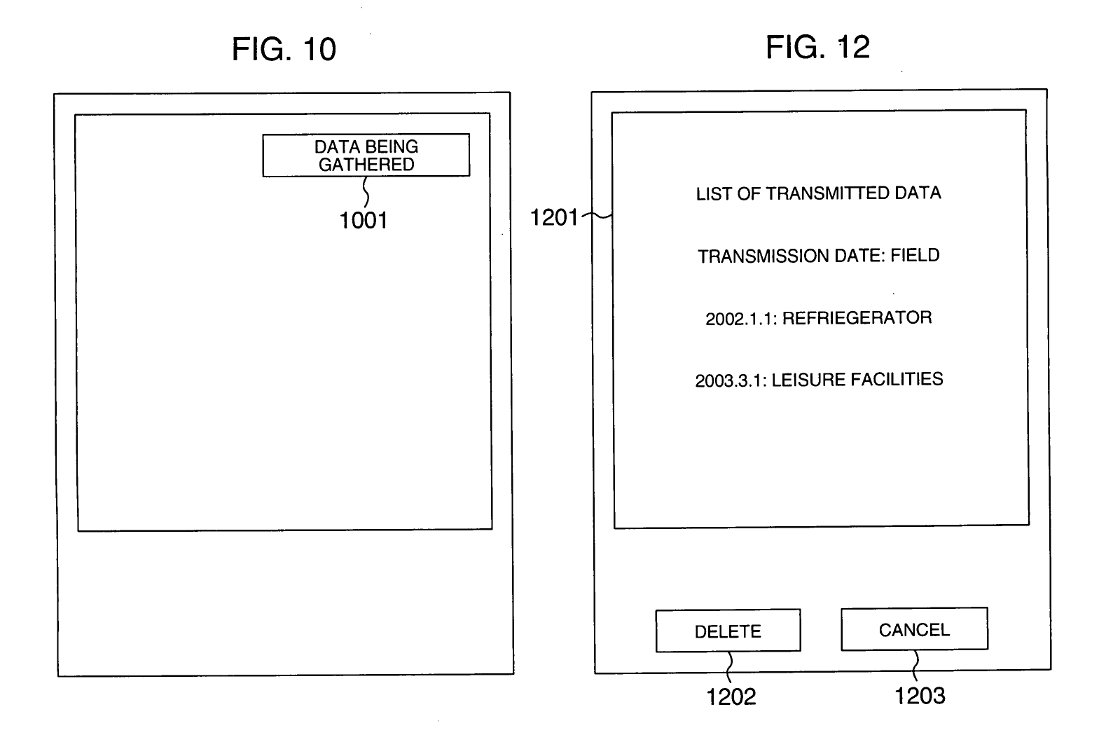

In order to avoid unexpected gathering of data from the information transmitted from the user, it is desirable to show the user that the KW recognition is being performed by display or the like. As shown in FIG. 10, an indication showing data being gathered 1001 is displayed on the screen while the KW recognition is performed. Alternatively, an icon or a mark may be displayed.

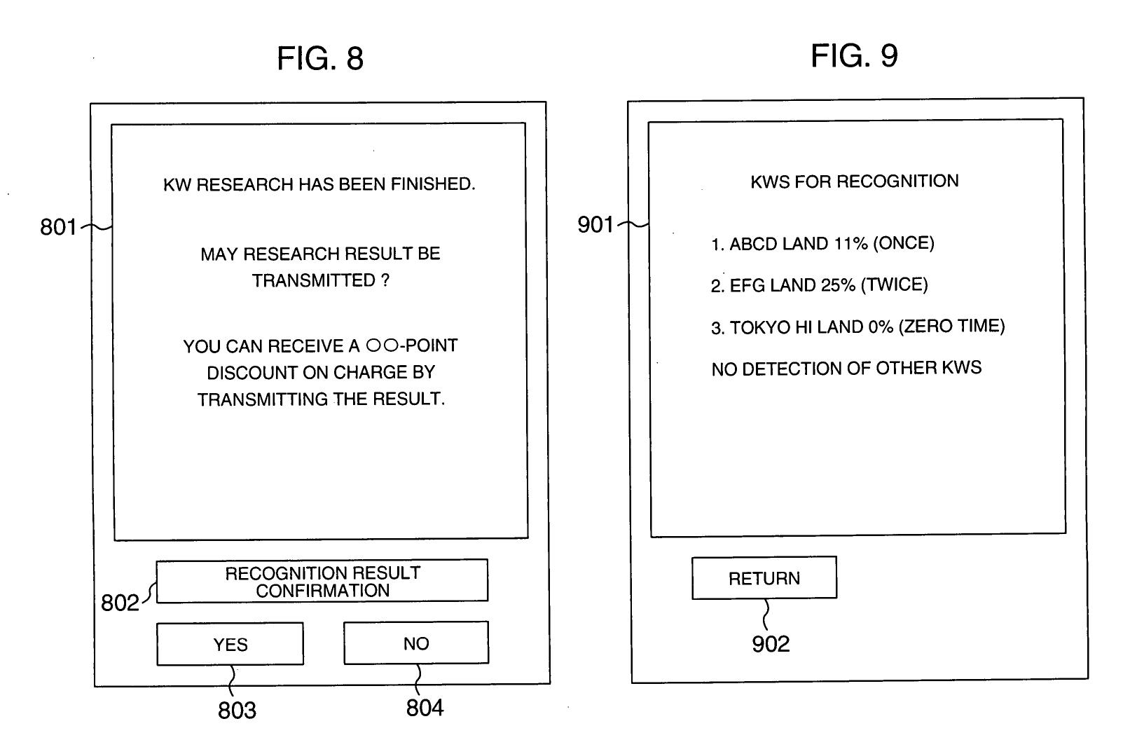

When the period specified for the research has been finished, the operation proceeds to step S307 in FIG. 3 to check whether the result of the research using the KW recognition performed by the terminal may be sent to the information gathering server or not. This step is performed for the same purpose as for the step S303 described before; thus, even if either of the processing at these steps is performed, the effect of getting the approval of the user can be obtained. An example of a confirmation screen for performing processing at step S307 is shown in FIG. 8.

Referring to FIG. 8, display 801 indicating that the research has been completed is performed on the screen, and input of confirmation whether the data on the result of the research may be transmitted to the information gathering server or not is received at the terminal. At this point, it is kinder to display an incentive for transmission of the data together on the display 801. When a recognition result confirmation button 802 in FIG. 8 has been selected, a recognition result display screen 901 in FIG. 9 is displayed. By displaying the result of the KW recognition before being transmitted to the information gathering server as described above, the user can actually confirm what information has been gathered. Thus, the user can use the information gathering system with a feeling of security. The number of times the KWs have been detected, KW occurrence rates with respect to the total number of KW occurrence times, and the like are displayed on the recognition result confirmation screen 901. When a return button 902 is selected, the screen is returned to the data transmission confirmation screen in FIG. 8.

When a “yes” button 803 in FIG. 8 has been selected, the operation proceeds to data transmission at step S308. When a “no” button 804 has been selected, the operation is finished without proceeding to the data transmission at step S308. At step S308, the result of the KW recognition held in the count data holding unit 9 is transmitted to the information gathering server through the communication unit 10 in FIG. 1. The information gathering server receives this data at step S325. Then, the operation proceeds to updating of user management information at step S324 and DB creation at step S326. Data reception at step S325 is repetitively executed during the period of the research whenever data transmission from the user is performed. For performing user management information at step S324, data on the received result of the KW recognition is stored in the user management information holding unit 23 shown in FIG. 1. Further, if the incentive such as a discount is granted when the research is performed, the incentive is recorded in the user information.

On the other hand, the DB creation at step S326 is executed by the DB creation unit 25 in FIG. 1. Based on the data on the result of the KW recognition transmitted from the terminal, the DB on the occurrence frequencies of the KWs being researched is newly created or updated.

As subsequent processing, at step S327 for transmitting accompanying information, a content obtained by the user from the research is transmitted to the terminal. The content obtained by the user includes accumulation of points due to the incentive or a communication charge discount, for example, both resulting from transmission of the data on the result of the KW recognition. Alternatively, transmission of information on a KW having a high occurrence frequency or information associated with the KW to the terminal in the research in which the user has participated may be performed.

The KW having the high occurrence frequency is the KW showing a much-talked-about or attractive target at the time of the research. Thus, by transmitting information on the target to the terminal, the user can obtain very fresh and useful information. Specifically, as the KW showing the much-talked-about or attractive target, a restaurant that is popular among office ladies can be pointed out. In this case, users targeted for the research are women in their twenties, and they are given the names of food and restaurants. On the other hand, if the communication content of a specific user frequently includes theme parks as dating spots, introduction of a theme park recommended for dating can also be performed.

Though a plurality of confirmation procedures are provided so as not to invade the privacy of the user as described above, the user, who is accustomed to this information gathering system and has faith in this system may consider these confirmation procedures bothersome. Thus, there is a need for providing a scheme that can set part or all of these confirmation procedures to be omitted.

The terminal receives the accompanying information at step S309 and displays them at step S310. When the research period has been completed, processing at step S328 is executed, so that the result of the research resulting from the KW recognition, held in the DB creation unit 25 in FIG. 1 is transmitted to the information research server. The information research server receives the result of the research at step S332 and performs output such as display, print-out, or the like. As in the case of the KW transmission at step S331, the information of the result of the research may also be transmitted orally or by paper, using mail, telephone or the like, as well as through communication over the data communication network. When the information research server has received the result of the research, the cost of the research and the like are paid to the information gathering server, and the incentive is paid to the user of the terminal, based on this cost.

FIG. 4 shows an example of data on a list of KWs for recognition to be transmitted from the information gathering server 42 to the terminal 41 shown in FIG. 1. Referring to FIG. 4, the data to be transmitted include an information gathering period 401, a field 402, an incentive 404, an encryption code 405, an information source 406, a positional information addition flag 407, an other party information addition flag 408, a before-and-after information addition flag 409, and speaker information addition flag 410, in addition to a list of KWs for recognition 403.

The information gathering period 401 shows the period for gathering data using the KW recognition, and is set based on the research period specified by the market research company. The field 402 stores information on the field to which the KWs for recognition to be transmitted belong. The terminal extracts information stored in the field 402 as necessary and uses the information for display on the screen when confirmation as to the start of the KW recognition is performed, for example. The incentive 404 is the information indicating the content of the incentive to be paid to the user for information gathering using the KW recognition, and is used for display on the screen when confirmation as to the start of the KW recognition is performed, for example. The encryption code 405 is the encryption key for encrypting data gathered using the KW recognition so that others cannot read and abuse the data when the data is transmitted to the information gathering server. The information source 406 specifies targets for the KW recognition. An example shown in FIG. 4 shows that the KW recognition is performed on a voice call and mail, thereby creating data.

The positional information addition flag 407 is the flag for storing positional information when a KW has been detected and specifying whether to transmit the positional information to the information gathering server or not. When the positional addition flag 407 is present and the KW is detected, information in the position detection unit 7 in FIG. 1 is stored in the count data holding unit 9 together with the detected KW. Like the positional information addition flag 407, the other party information addition flag 408 specifies information on the other party in a voice call or transmission of mail for storage together with the detected KW when the KW has been detected. The before-and-after information addition flag 409 specifies storage of a KW for evaluation together with the detected KW when the KW for evaluation has been detected within a specified range after the KW recognition has been performed. The speaker information addition flag 410 is the flag for specifying storage of information on a speaker together with the KWs and transmission of the information on the speaker to the information gathering server 42 as data.

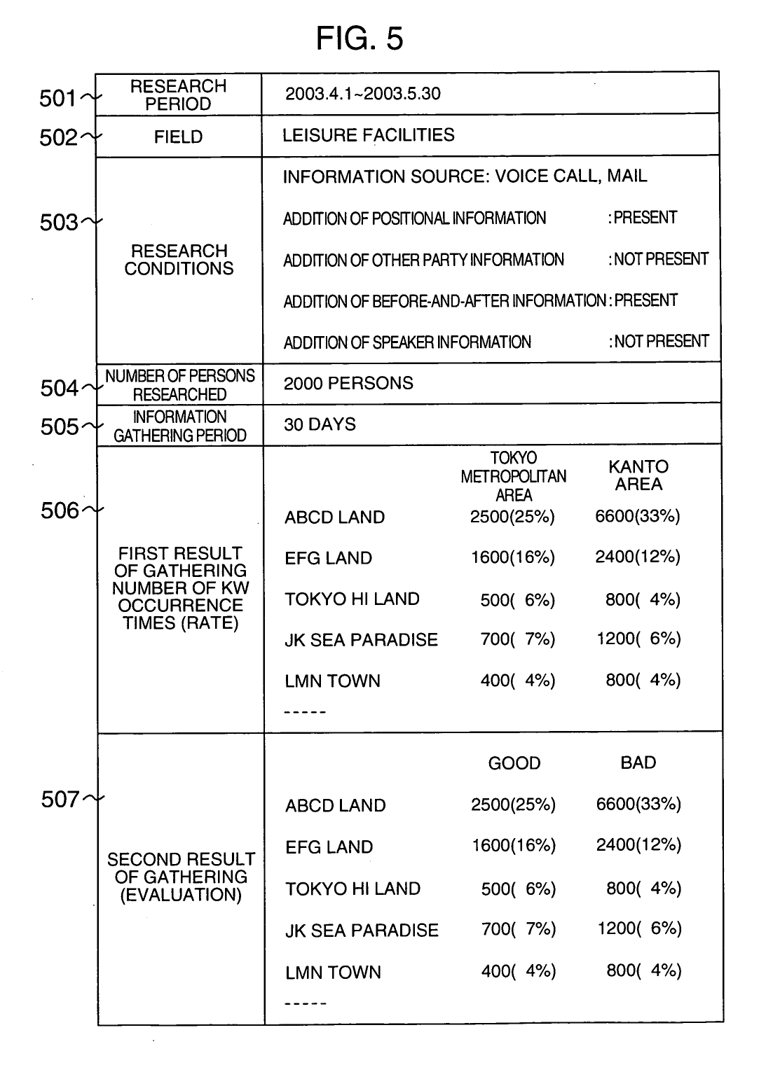

FIG. 5 is an example of data received and transmitted between the information gathering server 42 and the information research sever 43. Referring to FIG. 5, a research period 501 specifies the period for performing the research. A field 502 shows the field to which a KW showing the field for recognition belongs. Among research conditions 503, the information source has the same meaning as the information source 406 described with reference to FIG. 4. The positional information addition flag, other party information addition flag, before-and-after information addition flag, and speaker information addition flag respectively have the same meaning as the positional information addition flag 407, other party information addition flag 408, before-and-after information addition flag 409, and speaker information addition flag 410, described with reference to FIG. 4. The number of persons researched 504 indicates the number of persons to whom a KW list is transmitted to perform data gathering. An information gathering period 505 indicates the period during which information gathering is performed at the terminal. When the period specified as the information gathering period has elapsed, the KW recognition at the terminal is stopped, and the data is transmitted to the information gathering server. Various patterns can be considered for display of the result of information gathering. In the example shown in FIG. 5, a first result of gathering 506 indicating a distribution of KW occurrence data by region and a second result of gathering 507 indicating a distribution of the KW occurrence data using evaluation KWs issued, being associated with the KWs are shown as the example of the data showing the result of the research. In addition to these data, display of the result of the KW recognition indicating KW occurrence by time or the result of the KW recognition classified according to the age, gender, or occupation of the user can be considered.

When transmitted from the information research sever 43 to the information gathering server 42, the data shown in FIG. 5 are employed as the data that specify the method of the research, and the data do not include the results of the KW recognition shown by the first and second results of gathering 506 and 507. When transmitted from the information gathering server 42 to the information research sever 43, the data shown in FIG. 5 are employed as the data that indicate the results of the research.

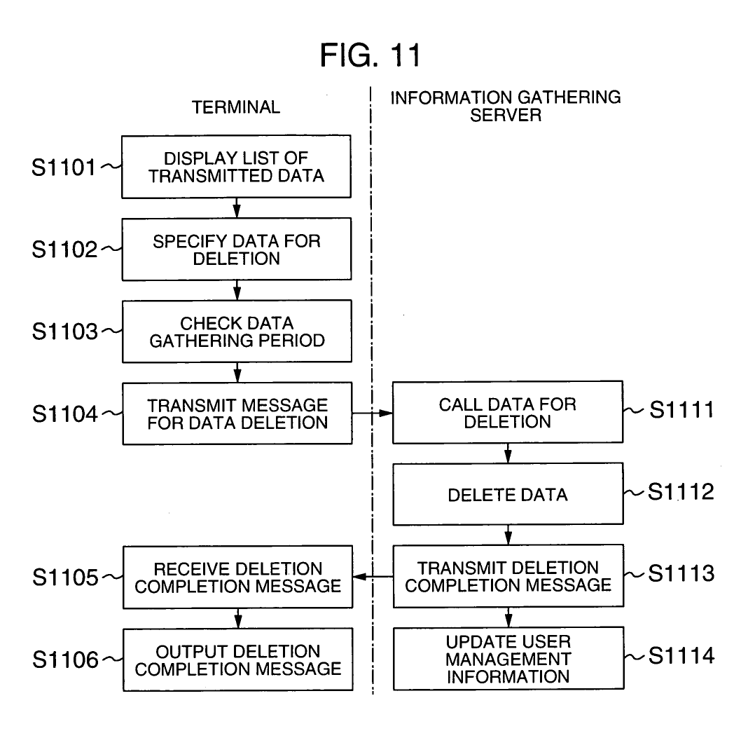

FIG. 11 is a flowchart showing a flow of processing implemented by a function of deleting transmitted data indicating the result of the KW recognition, once transmitted from the terminal 41 to the information gathering server 42, at the request of the user. Since the user has specific information extracted from his transmitted information due to the KW recognition, he may sometimes wish not to have the information extracted in terms of privacy. Further, even if the user has once transmitted data with the consent, he may change his mind later and wish not to use the data. In order to address this requirement, the scheme for deleting data once registered in the information gathering server later is provided for this information gathering system.

This scheme will be described with reference to a flowchart shown in FIG. 11. Referring to FIG. 11, it is assumed that the user has wished to delete transmitted data and invoked the function of deleting transmitted data. Then, processing at step S1101 is executed, so that a list of transmitted data is displayed. In this case, there is no need to display all the transmitted data; and a list of data transmitted before the end of a predetermined period may be displayed.

Next, at step S1102, data to be deleted is specified. The screen displayed at the terminal at this point is shown in FIG. 12. A list of transmitted data is displayed on a display screen 1201, where the data to be deleted is selected by an operation on the terminal. When a “deletion” button 1202 is selected, the operation proceeds to step S1103 shown in FIG. 11 to determine whether the transmitted data to be deleted is within the period of data gathering or not.

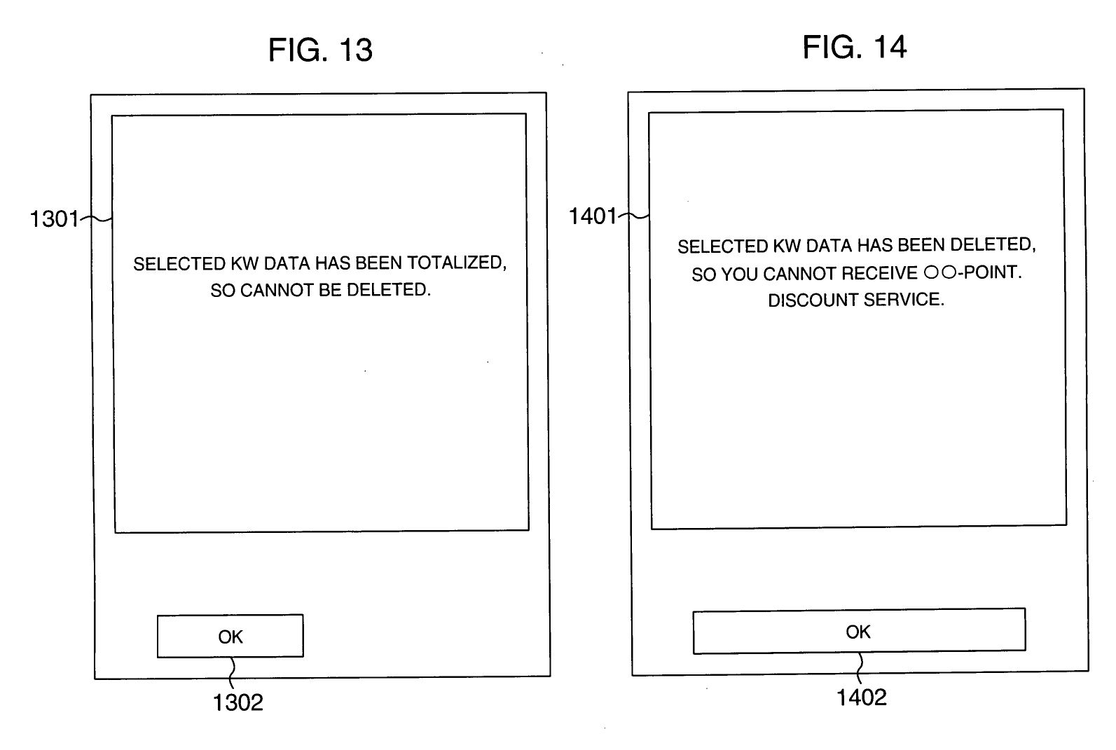

When it has been determined that the transmitted data to be deleted is within the gathering period, the data can be deleted by the information gathering server, and the count value for the data can be cancelled from the result of totalization. Thus, the operation proceeds to step S1104, and a message for deleting the data is transmitted to the information gathering server. On the other hand, when the gathering period has elapsed, the data have already been totalized and transmitted to the information research server. Thus, deletion of the data cannot be performed. In this case, a message 1301 to the effect that deletion cannot be performed is displayed, as shown in FIG. 13. Then, the processing is completed.

When receiving the message transmitted from the terminal at step S1104, processing at step S1111 is performed at the information gathering server to call the data for deletion. During the data gathering period, the transmitted data is stored in the user management information holding unit 23 described with reference to FIG. 1. At this step, the transmitted data is called up. Then, at subsequent step S1112, modification of the DB held in the DB creation unit 25 is performed by referring to the count value for the transmitted data, and then the transmitted data is deleted. When deletion of the data is completed, the operation proceeds to step S1113, and a message indicating deletion completion is transmitted to the terminal.

When the terminal has received the message indicating the deletion completion at step S1105, display of the deletion completion is performed at step S1106. An example of display on the screen at this point is shown in FIG. 14. Referring to FIG. 14, display 1401 to the effect that specified transmitted data has been deleted is displayed on the screen. Then, the user selects an OK button 1402 to finish processing at step S1106 in FIG. 11. Finally, at the information gathering server in FIG. 11, the operation proceeds to user management information updating at step S1114. At this step, processing for deleting the incentive granted to the user when he transmitted the data to the information gathering server is performed. The user management information holding unit 23 in FIG. 1 also holds information on the incentive granted to each user, and the incentive associated with the deleted transmitted data is cancelled.

As described above, the KW recognition is performed using voice or data indicated by characters or the like, commonly input to and output from the terminal, and information is obtained from the KW recognition. Thus, subconscious information of the user can be acquired without making the user conscious of having his information gathered from him. Further, since KWs are selected in advance, and the KW recognition is performed by detecting the KWs matching or associated with the seleted KWs from an input to or an output from the terminal, the burden placed on processing at the terminal is more reduced than in the case where recognition of all KWs is performed. Thus, even the terminal that does not have a high processing capability can perform sufficiently practical recognition in a background such as communication processing. Further, by specifying KWs for recognition in advance, the effect of obtaining privacy information such as user's personal information is achieved. Thus, the effect of increasing the feeling of security of the user whose information is gathered is also achieved.

It should be further understood by those skilled in the art that although the foregoing description has been made on embodiments of the invention, the invention is not limited thereto and various changes and modifications may be made without departing from the spirit of the invention and the scope of the appended claims.

1. An information gathering system having terminals connected to a network and a center including servers connected to a network, for acquiring specific information from information input to the terminals:
wherein a keyword list is transmitted from the center to the terminals; and
the center receives from each of the terminals a number of information matching or associated with at least one keyword in the keyword list and the keyword corresponding to the number of the information, the information being input to each terminal by users, thereby acquiring the specific information.

2. The information gathering system according to claim 1, wherein the center receives information on characteristics of each of the users of the terminals together with the number and the corresponding keyword, obtained at said each of the terminals.

3. The information gathering system according to claim 1, wherein the center transmits to the terminals a period of acquiring the specific information by the center so as to cause the users to confirm the period.

4. The information gathering system according to claim 1,
wherein the center classifies the specific information received from the terminals according to characteristics of the users; and
the center transmits the information classified according to the characteristics of the users to the terminals when a part of the characteristics used for classification matches a part of characteristics of a specific user.

5. An information gathering method for acquiring specific information from information input to terminals in a system with the terminals and a center including servers connected to the terminals via a network, the method comprising the steps of:
transmitting a keyword list from the center to the terminals;
specifying at least one or more keywords from the received keyword list in advance on the terminals;
obtaining by each of the terminals a number of information matching or associated with one of said at least one or more keywords from the information input to the terminals by users; and
transmitting the number of the information and the keyword corresponding to the number of the information, obtained at said each of the terminals, from said each of the terminals to the center, thereby acquiring the specific information by the center.

6. The information gathering method according to claim 5,
wherein the center receives information on characteristics of each of the users of the terminals together with the number and the corresponding keyword, obtained at said each of the terminals, thereby acquiring the specific information.

7. The information gathering method according to claim 5,
wherein the center transmits a period of acquiring the specific information to the terminals; and
the terminals output the period received from the center on respective displays thereof so as to cause the users to confirm the period.

8. The information gathering method according to claim 5,
wherein the center classifies the specific information received from the terminals according to characteristics of the users; and
the center transmits the information classified according to the characteristics of the users to the terminals when a part of the characteristics used for classification matches a part of characteristics of a specific user.

9. A personal digital assistant used in an information gathering system with personal digital assistants and a center including servers connected to the personal digital assistants via a network, for acquiring specific information from information input to the personal digital assistants, the personal digital assistant comprising:
a receiving unit for receiving a keyword list from the center;
a storage unit for storing the received keyword list;
a specifying unit for specifying at least one or more keywords in advance from the stored keyword list;
a counting unit for counting a number of information matching or associated with one of said at least one or more keywords in the information input by a user; and
a transmitting unit for transmitting to the center the number of the information and the keyword corresponding to the number of the information.

10. The personal digital assistant according to claim 9,
wherein information on characteristics of the user, held by the personal digital assistant is transmitted to the center together with the number and the corresponding keyword, obtained at the personal digital assistant.

11. The personal digital assistant according to claim 9,
wherein the receiving unit receives a period of acquiring the specific information from the center; and
the period received from the center is output on a display of the personal digital assistant.

12. The personal digital assistant according to claim 9,
wherein the information input to the personal assistant is voice data or text data.
